(19) United States
(12) Patent Application Publication
(10) Pub. No.: US 2004/0078098 A1
(43) Pub. Date: Apr. 22, 2004

(54) Computer system for assessing hazards

(76) Inventor: Owen Jeffries, (US)

Correspondence Address: David J. Simonelli, Clark Hill PLC, Suite 3500, 500 Woodward Avenue, Detroit, MI, 48226-3435, US

(21) Appl. No.: 10/684,610

(22) Filed: Oct. 14, 2003

(30) Foreign Application Priority Data
Apr. 12, 2001 (AU) PR4413
Jul. 25, 2001 (AU) PR6602
Apr. 11, 2002 (WO) 02/084519

(51) Int. Cl. G05B 11/01; G05B 13/02

(52) U.S. Cl. 700/52; 700/23; 700/30

(57) ABSTRACT

A computer system for assessing workplace hazards presents potential hazards to a user as a series of questions, which a user can select as being relevant or not to a particular task being carried out. All the data is stored in a database (10) with the different categories of hazards being associated with different work areas. Potential hazards are presented to the user and selected, if relevant. Where potential hazards are identified appropriate exposure avoidance controls are identified. A reporter generates a report setting out identified hazards and their avoidance controls. Permits and equipment data are also stored in the database and included in the report. Risk ratings are also provided for each identified risk. By providing a predefined database of hazards, avoidance controls and associated risk rating for each hazard, user subjectivity and human error are significantly reduced. In addition, the report generated by the computer system provides a mechanism for manually calculating the user-perceived risk of each hazard so that it may be contrasted with the computer-generated risk rating for that hazard. This will be of assistance for user assessment of the task to be performed and its associated risk.

### FIELD OF THE INVENTION

This invention relates to a computer system for assessing hazards. The invention has particular, although not exclusive, utility in relation to assessing work place safety hazards.

### BACKGROUND ART

Job safety analysis and risk assessment are vital components in preventing work place injuries and the associated loss of productivity.

To date, job safety assessment involves assessing potential hazards and determining what actions and/or equipment are required to minimise or eliminate the possibility of injury. This is currently performed using a printed risk assessment sheet that is completed prior to commencing work on a particular task.

The printed risk assessment sheet is an empty table divided into at least the following columns:

job steps;

hazards; and

controls.

In completing the risk assessment, the person to perform the task deconstructs the job into a series of steps which are then recorded in the job steps column. The person then identifies the hazards associated with each step entered in the job steps column and records these hazards in the hazards column. Finally, the person identifies those controls associated with the hazards and records these controls in the controls column.

In this manner, hazard data is dependent on step data and control data is dependent on hazard data. However, as the step data is dependent on the perception of the person completing the task, there can be significant inconsistencies in hazard assessments of the same task.

Additionally, completing the printed risk assessment sheet takes considerable time and is tedious for the user. This situation is further exacerbated because the job safety sheet needs to list all possible hazards and corresponding exposure avoidance controls for the task.

### DISCLOSURE OF THE INVENTION

Throughout the specification, unless the context requires otherwise, the word “comprise” or variations such as “comprises” or “comprising,” will be understood to imply the inclusion of a stated integer or group of integers but not the exclusion of any other integer or group of integers.

In accordance with one aspect of this invention, there is provided a computer system for assessing hazards, comprising:

a database storing hazard data, safety requirement data and work data, the safety requirement data being associated with the hazard data and the hazard data being associated with the work area data;

first interface arranged to present potential work areas from the work area data to a user, and to receive input from the user identifying the work area associated with a particular task;

second interface arranged to present potential hazards from the hazard data to the user, each potential hazard being associated with the work area identified by the user as associated with the particular task, and to receive input from the user identifying which potential hazards are associated with the particular task; and

reporter arranged to present to the user each hazard identified by the user for the task, and to present with each identified hazard the safety data associated with said hazard from the database.

In this manner, the present invention differs from the systems disclosed in WO 98/1147 (“Fetherston”) and U.S. Pat. No. 5,664,112 (“Sturgeon”) in two important aspects. Firstly, neither Fetherston nor Sturgeon discloses an interactive questioning environment. Instead, both the Fetherston and Sturgeon systems allow the user to search for information in respect of a particular hazard. Secondly, neither Fetherston nor Sturgeon discloses a relationship between work area data and hazard data as disclosed by the present invention.

Additionally, the present invention differs from the system disclosed in WO 99/59094 (“Shell Oil”) for reasons that the Shell Oil system does not incorporate a relationship between work area data and hazard data as disclosed above. The reference to work area data in the Shell Oil system being limited to simply recording the location of the identified hazard.

Preferably, the safety requirement data includes personal protective equipment data, safe working requirements data, equipment and permit data, each of which is associated with the hazard data.

Preferably, the database also stores risk-rating data, the risk rating data being associated with the hazard data, and wherein the reporter is arranged to present the risk rating associated with the hazard with each identified hazard.

Preferably, the computer system further comprises risk assessor arranged to present at least one question to an authorized person regarding a hazard in the hazard data, and to calculate from the authorized person's responses thereto a risk rating for that hazard, and to store the risk rating in the risk rating data associated with the hazard.

Preferably, said hazard data is arranged hierarchically to form hazard category data and hazard descriptor data, each hazard descriptor being associated with a hazard category, wherein said second interface is arranged to present to a user each hazard category, and if the user indicates a hazard category is applicable for the particular task to also present each hazard descriptor associated with that hazard category to the user, wherein the safety requirement data and risk rating data is associated with the hazard descriptor data.

Preferably, the database includes work type data, the work area data being associated with the work type data.

Preferably, the first interface and the second interface are combined.

In accordance with a second aspect of the invention there is a user computer for use in a computer system for assessing hazards, the user computer comprising:

communications means for receiving hazard data, safety requirement data and work area data from a database stored on a server computer, the safety requirement data being associated with the hazard data and the hazard data being associated with the work area data;

first interface arranged to present potential work areas from the work area data to a user, and to receive input from the user identifying the work area associated with a particular task;

second interface arranged to present potential hazards from the hazard data to the user, each potential hazard being associated with the work area identified by the user as associated with the particular task, and to receive input from the user identifying which potential hazards are associated with the particular task; and

reporter arranged to present to the user each hazard identified by the user for the task, and to present with each identified hazard the safety data associated with said hazard from the database.

Preferably, the safety requirement data received includes personal protective equipment data, safe working requirements data, equipment and permit data, each of which is associated with the hazard data.

Preferably, the communications means also receives risk-rating data from the database, the risk rating data being associated with the hazard data and the reporter being arranged also to present to the user the risk rating associated with the hazard with each identified hazard.

Preferably, the hazard data received is arranged hierarchically to form hazard category data and hazard descriptor data, each hazard descriptor being associated with a hazard category, wherein said second interface is arranged to present to the user each hazard category associated with the work area identified by the user as associated with the particular task, and, if the user indicates a hazard category as applicable for the particular task, to also present each hazard descriptor associated with that hazard category to the user, along with the safety requirement data.

Preferably, the communications means also receives work type data, the work type data being associated with the work area data.

Preferably, the first interface and the second interface are combined.

In accordance with a third aspect of the present invention there is a server computer for use in a computer system for assessing hazards, the user computer comprising:

at least one database, each database storing hazard data, safety requirement data and work area data, the safety requirement data being associated with the hazard data and the hazard data being associated with the work area data;

communicator for transmitting work area data and hazard data to an interface means of a user computer and receiving data from the interface means identifying the potential hazards associated with a particular task; and

reporter arranged to generate a report on each hazard identified by the user for the task, and to present with each identified hazard the safety data associated with said hazard from the database, the report being provided to a user of the user computer.

Preferably, the safety requirement data includes personal protective equipment data, safe working requirements data, equipment and permit data, each of which is associated with the hazard data.

Preferably, the at least one database also stores risk rating data, the risk rating data being associated with the hazard data, and wherein the reporter is arranged to present the risk rating associated with the hazard with each identified hazard.

Preferably, the server computer further comprises risk assessor arranged to present at least one question to an authorized person regarding a hazard in the hazard data, and to calculate from the authorized person's responses thereto a risk rating for that hazard, and to store the risk rating in the risk rating data associated with the hazard.

Preferably, the hazard data is arranged hierarchically to form hazard category data and hazard descriptor data, each hazard descriptor being associated with a hazard category, wherein said communicator is arranged to transmit hazard category data and hazard descriptor data to the interface.

Preferably, the at least one database includes work type data, the work area data being associated with the work type data.

Preferably:

each database is associated with at least one user having permission to access the database;

the communicator is adapted to transmit to the user computer operated by the at least one user, work area data and hazard data stored in the database that the user has permission to access; and

the reporter is adapted to generate the report on each hazard identified by the user for the task using data stored in the database that the user has permission to access, the report being provided to the at least one user of the user computer. The present invention therefore has the advantage that it provides a computer system that provides a convenient mechanism for efficiently producing a safety report for a particular task.

Additionally, by providing a predefined database of safety requirements and associated risk rating for each hazard descriptor, user subjectivity and human error are significantly reduced. In addition, the report generated by the computer system provides a mechanism for manually calculating the user-perceived risk of each hazard so that it may be contrasted with the computer-generated risk rating for that hazard. This will be of assistance for user assessment of the task to be performed and its associated risk.

### BRIEF DESCRIPTION OF THE DRAWINGS

Two embodiments of this invention will now be described with reference to the accompanying drawings, in which:

FIG. 1 is a schematic illustration of the computer device used for implementing the computer system of the present invention;

FIG. 2 shows the arrangement of data in the computer system for assessing hazards according to the first embodiment of the invention;

FIGS. 3A-3D show an example of a job safety analysis report produced by the computer system for assessing hazards according to the preferred embodiment of the invention;

FIG. 4 shows the risk assessment procedure utilized in the preferred embodiment of the invention;

FIG. 5 is a network diagram showing the computer system for assessing hazards according to the second embodiment of the invention and users' computers connected thereto via a data network;

FIG. 6 shows the arrangement of data in each database of the computer system for assessing hazards according to the second embodiment of the invention;

FIG. 7 is a flowchart of the operations that can be performed by a user on the computer system shown in FIG. 5;

FIG. 8 is a schematic illustration of a form, as presented to a user of the system for entering general details for preparing a hazard report; and

FIG. 9 is a schematic illustration of the manner in which hazard descriptor questions are presented to a user.

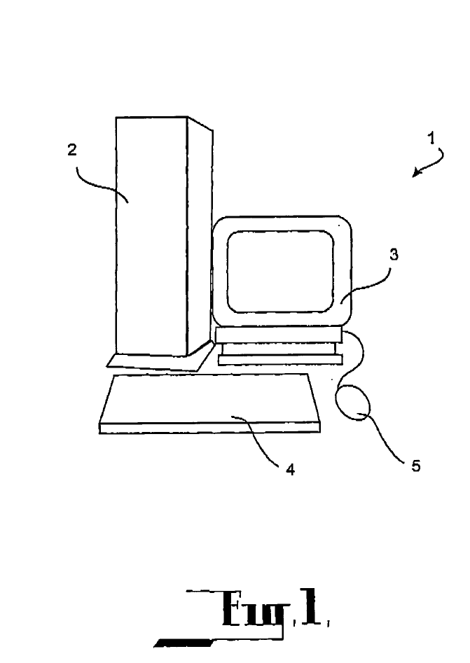

### BEST MODE(S) FOR CARRYING OUT THE INVENTION

The embodiments are directed towards a computer system for assessing work place hazards. However, it should be appreciated that the invention may be utilized in other fields where assessment of hazards and risk is required.

The computer system of the first embodiment is implemented using any suitable computing device, such as a desktop computer, a portable computer or a digital assistant or computational tablet. Any suitable computer device can be used, provided it is capable of running appropriate software. In this embodiment, the computer device is a desktop personal computer 1 comprising a processing unit 2, display 3, keyboard 4 and mouse 5. Such personal computers are well known in the art and, as such, need not be described in any further details here in except as is relevant to the present invention. The processing unit 2 includes appropriate memory and processor—again as is well known in the art—and which executes computer software to provide the computer system for assessing hazards.

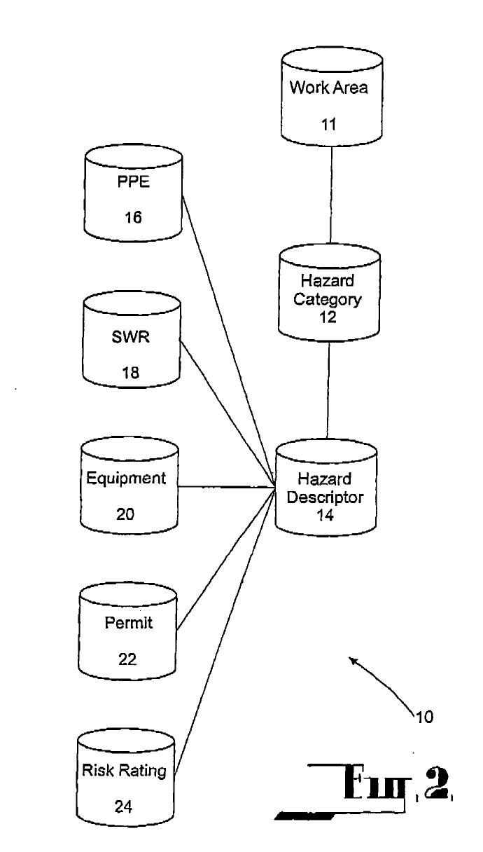

The computer system includes a database 10, which is shown in FIG. 2. The database 10 can be provided within memory in the computer 1, or can be located elsewhere and accessed remotely—as will be discussed in relation to the second embodiment below. The database 10 stores several types of data, including work area data 11, hazard category data 12 and hazard descriptor data 14.

The work area data 11 includes information regarding the physical area or location where the work it is to be carried out, or it could relate to a particular type of work carried out.

The hazard category data 12 comprises categories of potential hazards, and the hazard descriptor data 14 comprises hazard descriptor questions 46. Each hazard descriptor question 46 in the hazard descriptor data 14 is linked to a hazard category in the hazard category data 12. The hazard category data is linked to the work area data 11. The hazard descriptor questions 46 are used to identify hazards associated with a particular category of hazard. By presenting the potential hazards as questions the user is able to more easily identify possible hazards associated with a particular task.

The database 10 also includes personal protective equipment (PPE) data 16, safe working requirements (SWR) data 18, equipment data 20, permit data 22 and risk rating data 24, each of which are linked with one or more of the hazard descriptor questions 46 in the hazard descriptor data 14—and which are used to provide exposure avoidance controls 48 to assist users in avoiding identified hazards for a particular task.

The database 10 can also store general information, for example about the user.

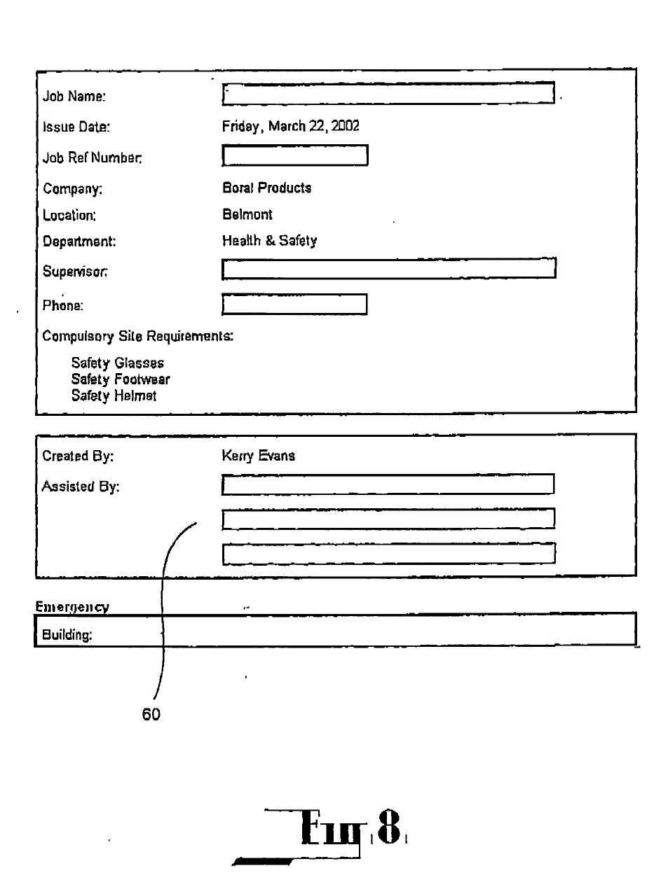

In use, to produce a safety report 54 for a particular task or job, the user firstly inputs general information, such as user details, and reference details about the particular task, and selects the appropriate work area—for the task—from the work area data 11. This is done by entering the details in a form 60 presented to the user on the display 3—as illustrated schematically at FIG. 8.

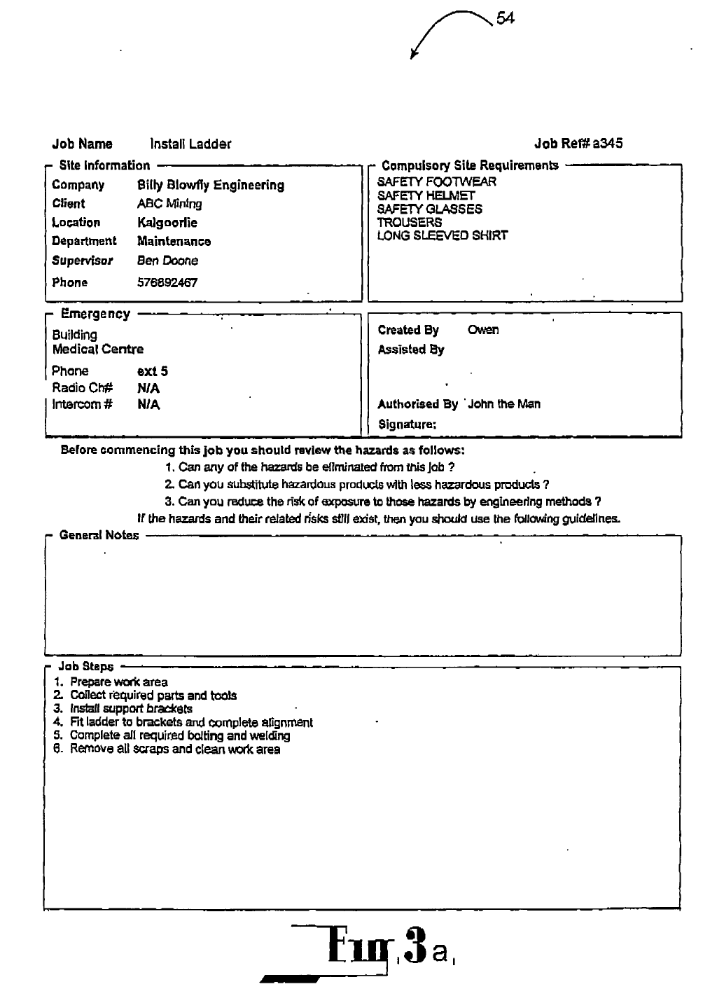

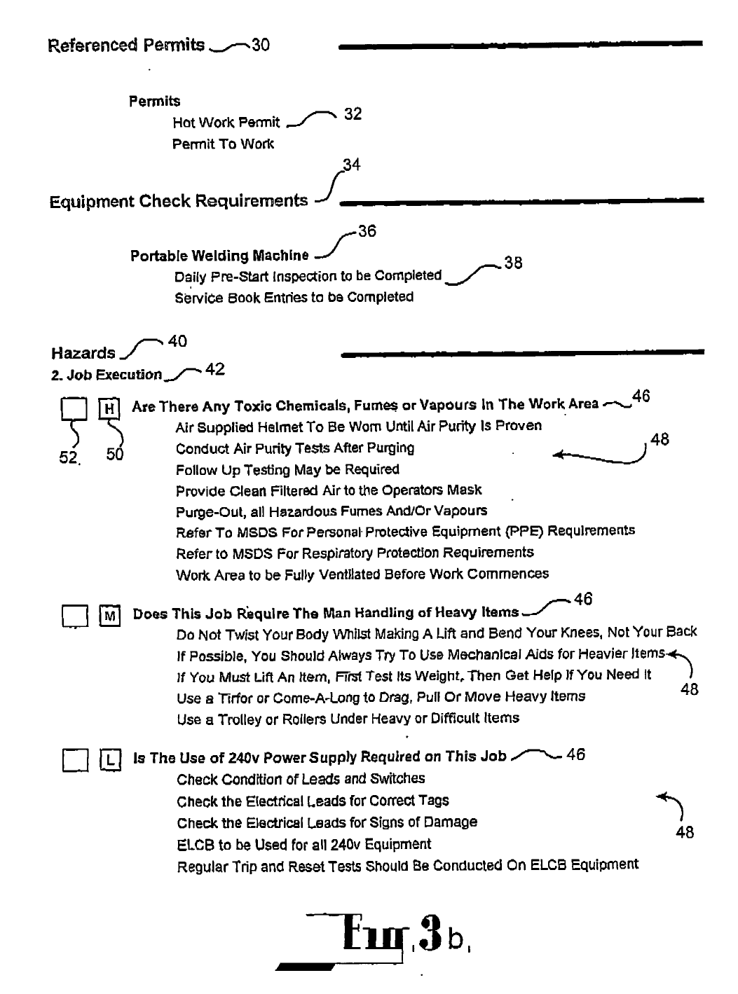

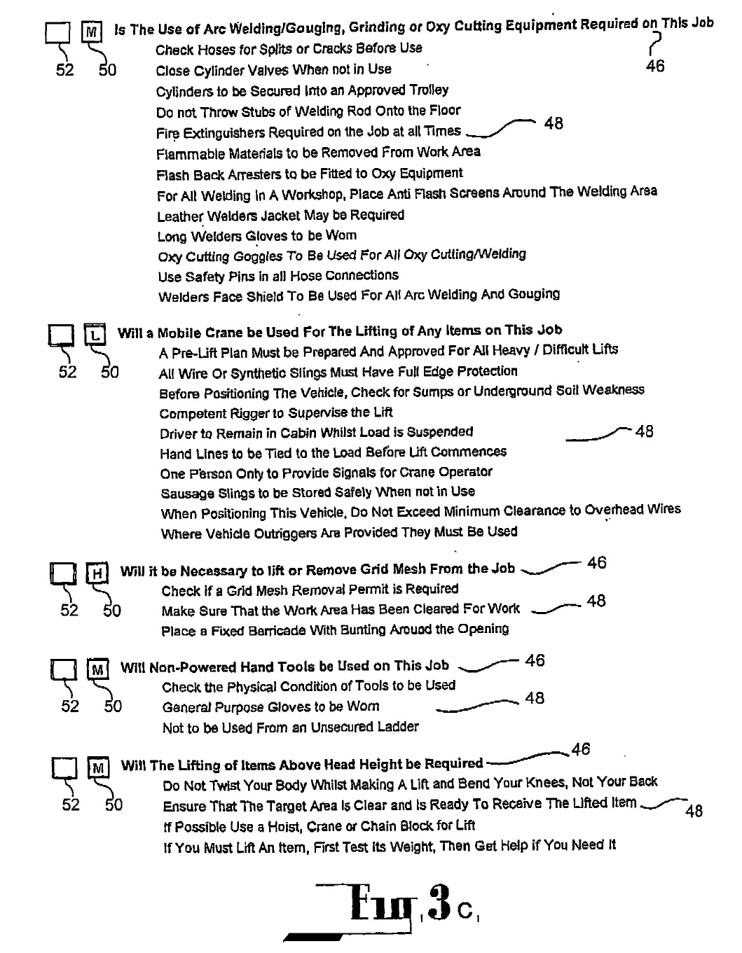

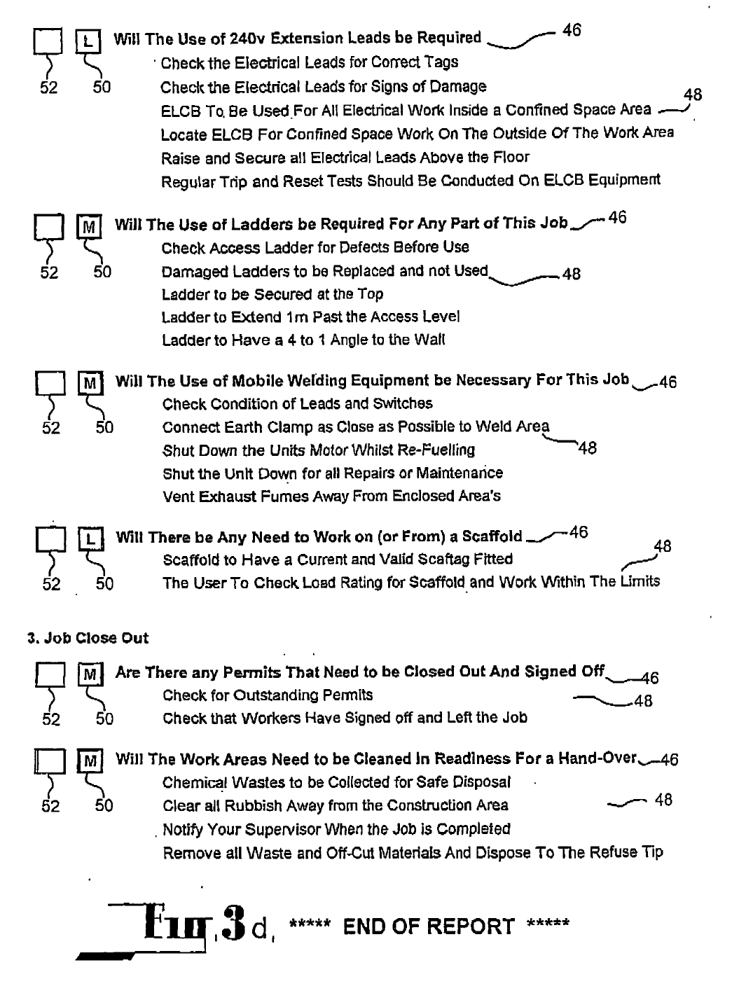

The computer system is then operable to present to the user—on the display 3—a series of questions which ask whether each of the hazard categories stored in the hazard category data 12—and that are linked to the selected work area—is applicable to this task. If the user answers “no,” i.e. that it is not relevant, then a question corresponding to the next hazard category from the hazard category data 12 is presented to the user. If the user indicates that a hazard category from the hazard category data 12 is applicable to this task, by answering “yes”, then the computer software references the hazard descriptor data 14 that is linked to that identified hazard category and presents, to the user, those hazard descriptor questions 46 which are applicable to this task. Thus, for a particular work area, the user is presented with hazard descriptor questions 46 that are linked to that work area. The user can then answer “yes” or “no” to each of these hazard descriptor questions 46. By answering “yes” or “no” to each presented hazard descriptor question 46, the user is selecting whether that particular hazard is relevant to that particular task or job. Examples of hazard descriptor questions 46 are shown in FIGS. 3B to 3D—where they are printed in the final safety report 54.

This process is repeated until all of the hazard categories from the hazard category data 12 and relevant hazard descriptor questions 46 from the hazard descriptor data 14 have been presented to the user, and answered.

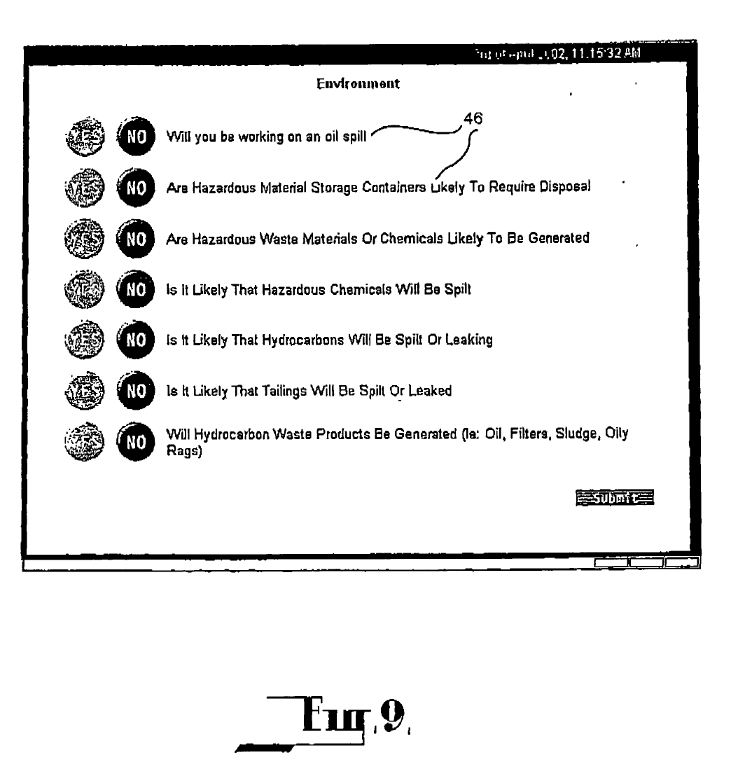

FIG. 9 is an example of the form in which these questions 46 are presented to the user at the display 3. In this example, the questions relate to potential environmental hazards.

The database 10 is structured as a relational database that is queried using the Structured Query Language or any other suitable query language.

The database 10 is queried in a manner such that, when a user selects a particular hazard category as applicable to that task—that is by answering “yes” when presented with a question asking if that hazard category is relevant—then the user is immediately presented with the hazard descriptor questions 46 linked to that hazard category data 12, before being able to proceed to the next hazard category question linked to that work area data 11. That is, the data within the database 10 is queried in a hierarchical manner, which means that a user must deal with each hazard category and it's related hazard descriptor questions 46, before proceeding with the next. In addition, and before a user can move to the next hazard category or descriptor question, the user must answer the presented question—even to answer “no” i.e. to indicate that the hazard category.

The work area related hierarchical ordering of the hazard categories and hazards prevents the user being required to answer a large number of questions which may not be relevant to the particular tasks they are to perform.

The computer software then references the PPE data 16, the SWR data 18, the equipment data 20, the permit data 22 and the risk rating data 24 linked with each hazard descriptor question 46 identified by the user as being relevant to the task to be performed, to identify the required exposure avoidance controls 48, as well as any permits and the risk ratings for each hazard—as will be discussed in further detail below.

Once all the relevant hazard descriptor questions 46 have been answered, and the equipment, permits and risk ratings linked to selected hazard descriptor questions 46 identified, then the computer software is operable to produce the safety report 54, an example of which is shown in FIGS. 3A to 3D.

The first section of the report (FIG. 3A) includes the general information and any appropriate general or mandatory safety requirements.

As shown in FIG. 3B, the safety report 54 includes a permit section 30 in which any permits that may be required in order to perform the task having regard to the nature of the hazards and equipment to be used are listed at 32. The permits 32 shown in the permits section 30 are obtained by referencing the permit data 22 linked with each selected hazard descriptor question 46 in the hazard descriptor data 14 and identified by the user as being applicable to the relevant task and by collating all of the permits.

The safety report 54 also includes an equipment check requirement section 34, in which each piece of equipment 36 identified by the user as being applicable to the task and which may be hazardous is listed, along with equipment check requirements 38 for that piece of equipment 36. The equipment check requirement section 34 is populated from the equipment data 20 by referencing those parts of the equipment data 20 that are linked with the hazard descriptor questions 46 in the hazard descriptor data 14 and identified by the user as being applicable for this task.

The safety report 54 also includes a hazards section 40 that comprises a job execution portion 42 and a job closeout portion 44. The hazard section 40 includes all those hazard descriptors—in the form of the hazard descriptor questions 46—as identified by the user as being relevant to the task, along with those exposure avoidance controls 48 that are linked to each of the hazard descriptor questions 46. The exposure avoidance controls 48 are obtained by referencing the PPE data 16, the SWR data 18 and the equipment data 20 linked to the particular hazard descriptor 46.

Adjacent to each hazard descriptor 46 is listed a risk rating 50 obtained by referencing the risk rating data 24 linked with the particular hazard descriptor 46. The risk rating shown at 50 is categorized as either L, M, H or E corresponding with low, medium, high ane extreme risk, respectively.

Further, the report includes a space at 52 that is initially empty, and which is for the user to manually assess the risk and enter it in situ.

The user may use the report as-is, or, preferably, will insert a user-perceived risk indication for each hazard descriptor 46.

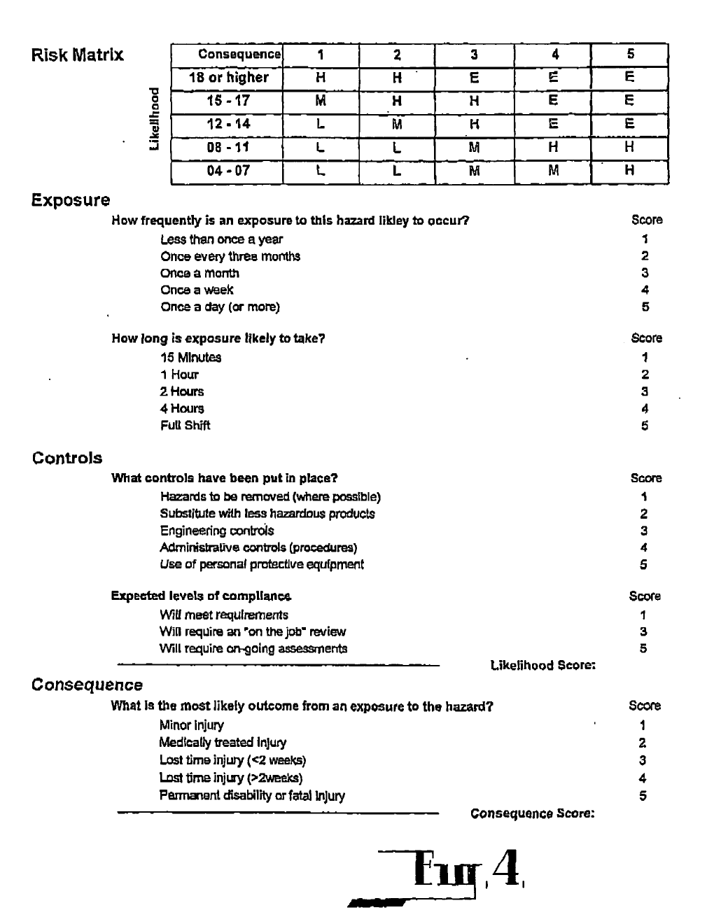

To provide a user-perceived risk indication for each hazard descriptor 46, the user answers the five questions that are shown in FIG. 4 under headings, Exposure, Controls and Consequence. The five questions are presented to the user on the display 3 for the user to answer. Each question has a multiple-choice answer, with each answer having a corresponding score as shown in FIG. 4. The user then sums the scores for the questions under the headings Exposure and Controls to calculate a likelihood value. This likelihood value along with the score associated with the user's answer to the question under the heading Consequence is cross-referenced with the risk matrix shown in FIG. 4 in order to determine the user-perceived risk indication for the hazard descriptor 46. The user-perceived risk indication is then entered by the user in the space 52 adjacent that particular hazard descriptor 46. This assessment is preferably performed in situ at the site where the task will be performed. This allows a comparison of the risk rating obtained from the computer system for a hazard to be compared with the user's assessment of the risk of that hazard having regard to the circumstances of the particular task. If there is a discrepancy between the two risk ratings, the user can take appropriate action to ensure they are not exposed to additional hazards.

In this embodiment, the database 10 can be edited by authorized persons with appropriate privileges to add, edit and remove data to any of the data categories 11-24. An authorized person may also edit the links between the hazard category data 12 and the hazard descriptor data 14, and between the hazard descriptor data 14 and each of the data categories 16-24. It is preferred that where the authorized person wishes to edit the risk rating for a particular hazard, or to determine the risk rating for a newly created hazard in the second hazard data 14, the computer system presents the authorized person with the same questions that are shown in FIG. 4, and which are used in determining the user-perceived risk, so that the predefined risk rating 24 is determined in accordance with the same criteria as those used to assess the user-perceived risk.

The second embodiment is directed towards a computer system 100 of the same general form as the computer system of the first embodiment. The same reference numerals are used to denote like parts to those in the first embodiment.

The computer system 100 differs from the computer system of the first embodiment in that it is arranged to communicate via a data network 102 such as the Internet.

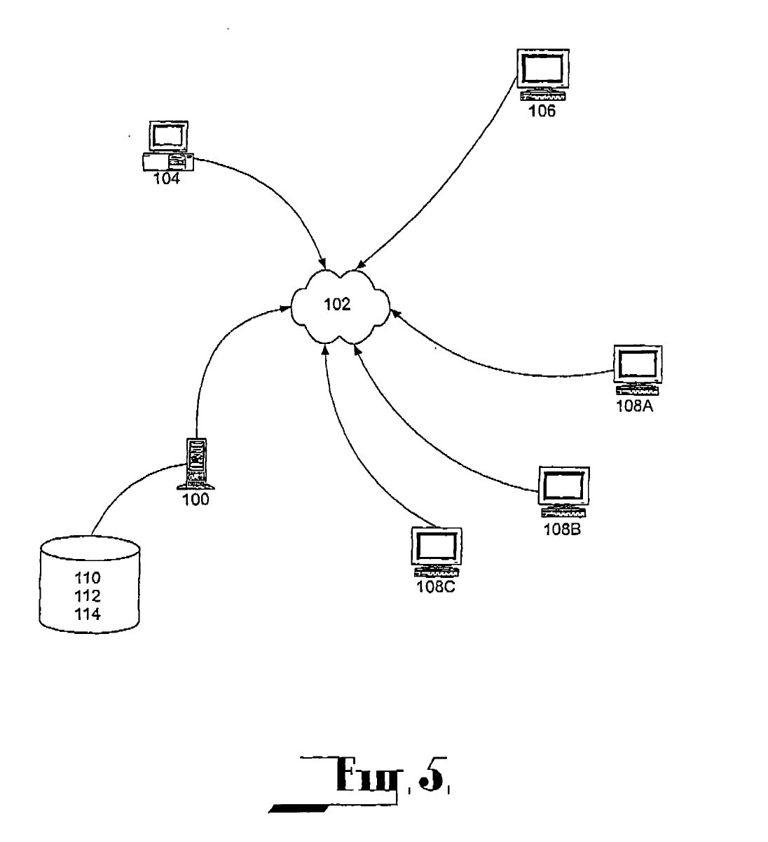

In the embodiment, the computer system 100 is accessed on a casual basis by a first user 104, and on a subscription basis by a second user 106 that requires the ability to produce safety reports for a single site and a third user 108a, 108b and 108c that requires the ability to produce safety reports for three sites denoted by the suffixes a, b and c. As shown in FIG. 5, each of the users 104, 106, and 108 is connected the data network 102 by appropriate computer facilities—such as a personal computer.

The computer system 100 includes a database 110, a first user database 112 and a second user database 114. Each of the databases 110, 112 and 114 is of the same general form, which is illustrated in FIG. 5. As shown, the databases 110, 112 and 114 are similar to the database 10 of the first embodiment, with the addition of work type data 116 thereto. The work type data 116 is linked to work area data 11, so that once a user has specified a work type, possible work areas linked to the selected work type are presented for selection, from which the process of creating a safety report proceeds as described above.

In this embodiment, the subscription-based users 106 and 108 may be corporations with many employees that access the computer system 100 using user names and passwords. Since these corporations may require the ability to customise entries in the database according to their requirements, the computer system 100 includes the user databases 112 and 114 that are associated with the users 106 and 108, respectively. When an employee of either of the users 106 or 108 that access the computer system 100, the computer system 100 determines the user 106 or 108 has a user database associated therewith, and references the associated user database instead of the database 110. Further, a system administrator can be appointed at each site of a corporation, who is responsible for assigning user names and passwords to employees. The term subscription user is used to include employees where the context is appropriate.

It should be appreciated that subscription users do not need to have an associated database, in which case its employees continue to access the database 110.

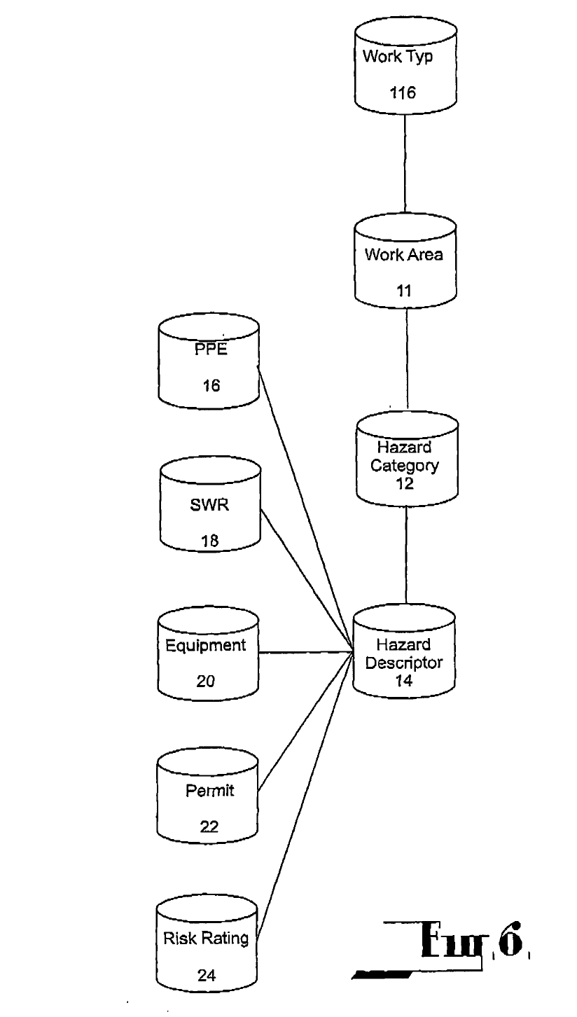

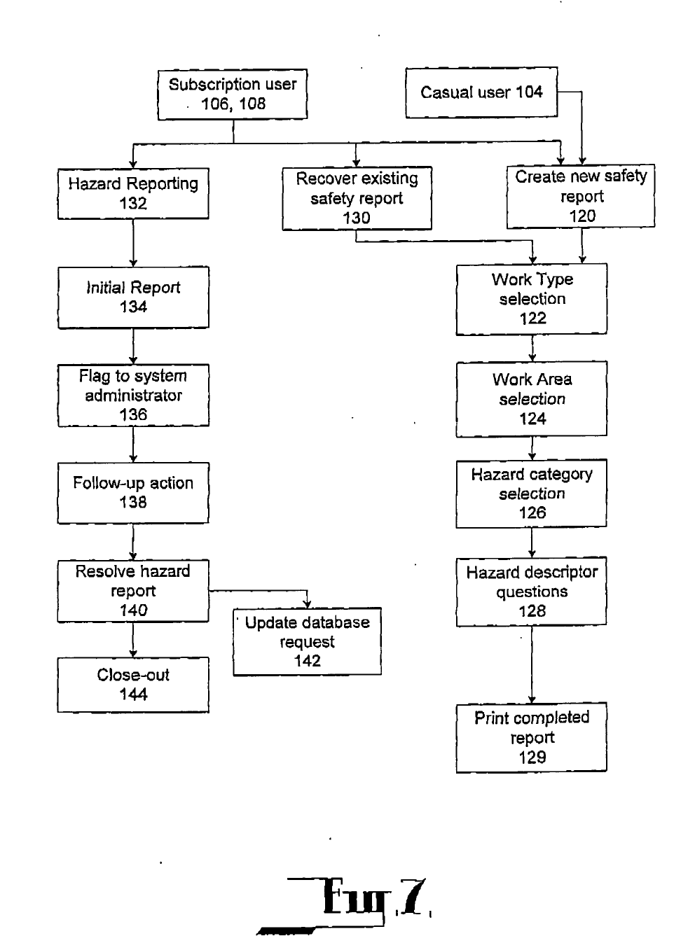

FIG. 7 is a flow diagram showing the operations that casual users and subscription users can perform using the computer system 100. As shown, casual users 104 can only create a new safety report at 120. The creation of new safety report is performed in the same general manner as described in relation to the first embodiment. In this embodiment, the user is first asked to select a work type from the work type data 116, shown in FIG. 6 at 122. The user then chooses a work area from the work area data 11 linked to the selected work type, shown in FIG. 7 at 124. The user is then presented with hazard categories from the hazard category data 12 at 126, from which the user selects those hazard categories that are applicable to the task. Next, for each hazard category selected as being applicable at the task, the user is presented with hazard descriptor questions from the hazard descriptor data 14 at 128.

Based on the user's answers to these questions, the computer system 100 then references the PPE data 16, the SWR data 18, the equipment data 20, the permit data 22 and the risk rating data 24 linked with each hazard descriptor question identified by the user as being relevant to the task to be performed and produces the safety report in the same manner as described above in relation to the first embodiment. This is shown in FIG. 7 at 129.

The safety report produced in this embodiment contains similar information to that shown in FIGS. 3A-3D, however the arrangement of the information may be altered.

Subscription users can also create a new safety report at 120 using the database 110 or a user database 112, 114 as appropriate.

Further, subscription users can recover a previously completed safety report at 130. This allows subscription users to quickly produce a safety report for a repeated task, or to use a safety report for a similar task as a starting point in producing a new safety report. Thus, having recovered an existing safety report, a subscription user can proceed to select a primary work type at 122.

In addition, subscription users can report a hazard at 132. A subscription user completes an initial report at 134 describing the hazard. This report is flagged to the system administrator within the subscription user corporation at 136. The system administrator within the subscription user corporation then performs a follow-up action at 138 by making any assessment of the hazard and the existing exposure avoidance controls that are linked to that risk. At 140, the system administrator resolves whether any change to the contents of the user database are required. If so, a request to amend the user database is submitted to the computer system 100 at 142, following which the user database is amended as requested. A hazard report may trigger a change in any of the work type data 116, work area data 11, hazard category data 12, hazard descriptor data 14, PPE data 16, SWR data 18, equipment data 20, permit data 22 and/or the risk rating data 24, according to requirements.

The system administrator then performs a closeout action on the hazard report at 142.

As mentioned above, in this second embodiment users access the system using the Internet, and each of the forms are presented to the user in the form of web pages with appropriate buttons or check boxes for selecting appropriate answers. The use and operation of the Internet and web pages for communicating data between terminals is well known to persons skilled in the art, and, in so far as it is not relevant to the present invention need not be described in any further detail herein. Other means of data communication can be used to transmit the data between the user and the system such as point-to-point transmission, wireless data communication, LAN's or any other suitable method.

The second embodiment provides a convenient system for allowing multiple users to produce safety reports and manage their databases from a central computer system. Further, provision is made for ad-hoc users to create safety reports on an as needed basis.

It should be appreciated that the scope of this invention is not limited to the particular embodiment described above. The system can also be adapted to include further data such as incident reporting and investigation, employee data, training information, workplace inspections, and site audits. In each case, the information can be suitably linked within the database to ensure that information is appropriately carried into the relevant reports, and trigger changes in the database 10, 110 as appropriate.

What is claimed:

1. A computer system for assessing hazards, comprising:
a database storing hazard data, safety requirement data and work area data, the safety requirement data being associated with the hazard data and the hazard data being associated with the work area data;
a first interface arranged to present potential work areas from the work area data to a user, and to receive input from the user identifying the work area associated with a particular task;
a second interface arranged to present potential hazards from the hazard data to the user, each potential hazard being associated with the work area identified by the user as associated with the particular task, and to receive input from the user identifying which potential hazards are associated with the particular task; and
a reporter arranged to present to the user each hazard identified by the user for the task, and to present with each identified hazard the safety data associated with said hazard from the database.

2. A computer system as claimed in claim 1, wherein the safety requirement data includes personal protective equipment data, safe working requirements data, equipment and permit data, each of which are associated with the hazard data.

3. A computer system as claimed in claim 1 wherein the database also stores risk-rating data, the risk rating data being associated with the hazard data, and wherein the reporter is arranged to present the risk rating associated with the hazard with each identified hazard.

4. A computer system as claimed in claim 3, further comprising risk assessor arranged to present at least one question to an authorized person regarding a hazard in the hazard data, and to calculate from the authorized person's responses thereto a risk rating for that hazard, and to store the risk rating in the risk rating data associated with the hazard.

5. A computer system as claimed in claim 1, wherein the hazard data is arranged hierarchically to form hazard category data and hazard descriptor data, each hazard descriptor being associated with a hazard category, wherein said second interface is arranged to present to a user each hazard category, and if the user indicates a hazard category as applicable for the particular task to also present each hazard descriptor associated with that hazard category to the user, along with the safety requirement data.

6. A computer system as claimed in claim 1, wherein the database includes work type data, the work area data being associated with the work type data.

7. A computer system as claimed in claim 1, wherein said first interface and said second interface are combined.

8. A user computer for use in a computer system for assessing hazards, the user computer comprising:
a communicator for receiving hazard data, safety requirement data and work area data from a database stored on a server computer, the safety requirement data being associated with the hazard data and the hazard data being associated with the work area data;
a first interface arranged to present potential work areas from the work area data to a user, and to receive input from the user identifying the work area associated with a particular task;
a second interface arranged to present potential hazards from the hazard data to the user, each potential hazard being associated with the work area identified by the user as associated with the particular task, and to receive input from the user identifying which potential hazards are associated with the particular task; and
a reporter arranged to present to the user each hazard identified by the user for the task, and to present with each identified hazard the safety data associated with said hazard from the database.

9. A user computer as claimed in claim 8, wherein the safety requirement data received includes personal protective equipment data, safe working requirements data, equipment and permit data, each of which are associated with the hazard data.

10. A user computer as claimed in claim 8, wherein the communicator also receives risk-rating data from the database, the risk rating data being associated with the hazard data and the reporter being arranged also to present to the user the risk rating associated with the hazard with each identified hazard.

11. A user computer as claimed in claim 8, wherein the hazard data received is arranged hierarchically to form hazard category data and hazard descriptor data, each hazard descriptor being associated with a hazard category, wherein said second interface is arranged to present to the user each hazard category associated with the work area identified by the user as associated with the particular task, and, if the user indicates a hazard category as applicable for the particular task, to also present each hazard descriptor associated with that hazard category to the user, along with the safety requirement data.

12. A user computer as claimed in claim 8, wherein the communicator also receives work type data, the work type data being associated with the work area data.

13. A user computer as claimed in claim 8, wherein the first interface and the second interface are combined.

14. A server computer for use in a computer system for assessing hazards, the user computer comprising:
at least one database, each database storing hazard data, safety requirement data and work area data, the safety requirement data being associated with the hazard data and the hazard data being associated with the work area data;
a communicator for transmitting work area data and hazard data to an interface of a user computer and receiving data from the interface identifying the potential hazards associated with a particular task; and
a reporter arranged to generate a report on each hazard identified by the user for the task, and to present with each identified hazard the safety data associated with said hazard from the database, the report being provided to a user of the user computer.

15. A server computer as claimed in claim 14, wherein the safety requirement data includes personal protective equipment data, safe working requirements data, equipment and permit data, each of which are associated with the hazard data.

16. A server computer as claimed in claim 14, wherein the at least one database also stores risk rating data, the risk rating data being associated with the hazard data, and wherein the reporter is arranged to present the risk rating associated with the hazard with each identified hazard.

17. A server computer as claimed in claim 16, further comprising a risk assessor arranged to present at least one question to an authorized person regarding a hazard in the hazard data, and to calculate from the authorized person's responses thereto a risk rating for that hazard, and to store the risk rating in the risk rating data associated with the hazard.

18. A server computer as claimed in claim 14, wherein the hazard data is arranged hierarchically to form hazard category data and hazard descriptor data, each hazard descriptor being associated with a hazard category, wherein said communicator is arranged to transmit hazard category data and hazard descriptor data to the interface.

19. A server computer as claimed in claim 14, wherein the at least one database includes work type data, the work area data being associated with the work type data.

20. A server computer as claimed in claim 14, wherein:
each database is associated with at least one user having permission to access the database;
the communicator is adapted to transmit to the user computer operated by the at least one user, work area data and hazard data stored in the database that the user has permission to access; and
the reporter is adapted to generate the report on each hazard identified by the user for the task using data stored in the database that the user has permission to access, the report being provided to the at least one user of the user computer.
